(19) United States
(12) Patent Application Publication
(10) Pub. No.: US 2018/0300324 A1
(43) Pub. Date: Oct. 18, 2018

(54) CONTEXTUALLY RELEVANT DOCUMENT RECOMMENDATIONS

(71) Applicant: MicroStrategy Incorporated, Vienna, VA (US)

(72) Inventors: Siamak Ziraknejad, Reston, VA (US); Ren-Jay Huang, Leesburg, VA (US); Liang Chen, Fairfax, VA (US)

(21) Appl. No.: 15/838,792

(22) Filed: Dec. 12, 2017

Related U.S. Application Data
(60) Provisional application No. 62/486,355, filed on Apr. 17, 2017.

(51) Int. Cl. G06F 17/30; G06F 15/18; H04W 4/02

(52) U.S. Cl. CPC G06F 17/30011; G06F 17/30705; H04W 4/02; G06F 15/18; G06F 17/30699

(57) ABSTRACT

Methods, systems, and apparatus, including computer-readable media, for contextually relevant document recommendations. In some implementations, a computing device receives context data indicating physical context of a mobile device, the context data indicating a second device in proximity to the mobile device. The computing device identifies a first user associated with the mobile device, and identifies a second user associated with the second device. The computing device identifies a document that is predicted to be relevant to the first user. For example, the document may be identified from among multiple documents in a document collection based at least in part on records indicating document accesses associated with the second user. While the second device is in proximity to the mobile device, the computing device provides data indicating the document that is predicted to be relevant to the first user.

### CROSS-REFERENCE TO RELATED APPLICATION

This application claims the benefit of U.S. Provisional Application No. 62/486,355, filed Apr. 17, 2017, and titled “Contextually-Relevant Document Recommendations,” which is incorporated by reference.

### BACKGROUND

This specification relates generally to providing document recommendations.

### SUMMARY

In some implementations, a recommendation system determines a current context of a mobile device and identifies documents that are relevant to that context. For example, the mobile device may receive wireless communications that indicate the presence of other devices nearby. These devices could include location beacons, mobile devices of other users, physical resources or assets nearby, or other types of devices. The current state of detected devices, as well as historical data and other associated data, can be used to generate real-time recommendations to a user. The recommendation system can integrate proximity data and identity data to predict which documents are relevant to a user in the current context, and provide a shortcut or quick launch option to display the documents.

The context information can use information about which documents are active or currently viewed on nearby devices. As an example, when a user walks into a room, the user's mobile device may detect the presence of other computing devices in the room. The recommendation system collects information about the current state of these nearby devices, including data indicating documents currently viewed on the devices. From this data, the system can then indicate the documents currently being viewed by others in the room as recommended documents for the user who just entered. As a result, if other users in the room are discussing a presentation or spreadsheet document that they are viewing, the document can be automatically indicated on the mobile device of the user that just entered the room. The indication can include an icon, hyperlink, or other reference that a user can interact with to initiate viewing the document on the mobile device.

Document recommendations can be customized for the current context of a mobile device based on various other factors, including which users are in the room, the relationship of the user of the mobile device to the other users, the location of the mobile device, and the date and time. The document access history of the user of the mobile device, as well as the document access history of other users present and even users who are not currently present can be used to further assess relevance to the current context.

Recommendations can be output to a user in a variety of ways. In some implementations, a user can request document recommendations, for example, by performing a swipe on a touchscreen or providing other user input to activate a recommendation menu. The client device can obtain data indicating recommended documents for the current context before the user initiates display of the recommendation menu. As a result, when the user requests to view recommendations, the client device already has the set of recommended documents available and can provide the documents with little to no delay. For example, the mobile device may communicate with a server on a periodic or ongoing basis to inform the server system of changes in the context of the mobile device. When the context of the mobile device changes, the mobile device may inform the server. The server, in response, provides recommendations to the mobile device that are determined to be appropriate for the current context.

The set of recommended documents can be dynamically changed as the context changes. For example, when the server determines a change in context, e.g., when the mobile device has moved to a new location, when the set of people detected nearby changes, or when the state of nearby devices changes, the server updates the set of recommended documents and informs the client device. The changes in the recommendations may be provided in substantially real time on the display of the mobile device. For example, if a mobile device of a first user detects a phone of a second user nearby, the mobile device may indicate a document that the first user and the second user both have in their respective document libraries. If the second user leaves and the phone is no longer detected, the recommendation of the document may be removed from display on the mobile device, in some instances, within a few seconds of determining that the phone is no longer present. When a phone of a third user is detected, a new document, different from the one previously recommended, can be indicated on the mobile device based on information about the third user. In this manner, indications of recommended documents can be added or removed as changes in context are detected.

In some implementations, recommended documents may be pre-cached or pushed to a mobile device so that they are subsequently available without incurring network transfer delays. For example, when the mobile device obtains data indicating recommended documents, an application on the mobile device can download one or more of the recommended documents to local storage of the mobile device. Once the mobile device downloads the recommended documents, the mobile device can provide a notification message to the user indicating that recommended documents are available. By interacting with the notification message, the user can view a list of the recommended documents stored locally at the mobile device, and select one of the documents for viewing. In this manner, the user does not perceive delays for transferring the documents over a network. Once the mobile device provides the notification message, the documents are already present on the mobile device so they can be displayed very quickly.

The recommendation system may provide multiple types of document recommendations determined using different sets of criteria. For example, different sets of recommended documents may be identified using different contextual factors. One set of recommendations may indicate documents that are relevant to a user's document access history, for example, taking into account document viewing patterns of the user including the history of document accesses at the current location of the mobile device. Another set of recommendations may indicate documents that are identified based on specific users identified near the mobile device. Another set of recommendations may indicate documents identified using a machine learning model, such as a neural network-clustering model that clusters users according to their document access histories. Recommended documents from each of multiple sets can be shown in a single user interface to provide relevant recommendations for different aspects of the current context of the mobile device and its user.

In one general aspect, a method includes: receiving, by one or more computers, context data indicating physical context of a mobile device, the context data indicating a second device in proximity to the mobile device; identifying, by the one or more computers, a first user associated with the mobile device; identifying, by the one or more computers, a second user associated with the second device; identifying, by the one or more computers, a document that is predicted to be relevant to the first user, the document being identified from among multiple documents in a document collection based at least in part on records indicating document accesses associated with the second user; and providing, by the one or more computers, data indicating the document that is predicted to be relevant to the first user while the second device is in proximity to the mobile device.

Implementations may optionally include one or more of the following features. For example, in some implementations, receiving the context data includes receiving, from the mobile device over a network, data indicating a set of identifiers extracted from wireless messages received by the mobile device from one or more devices in proximity to the mobile device, the set of identifiers including at least an identifier for the second device.

In some implementations, identifying the second user associated with the second device includes: accessing data indicating a mapping of identifiers to user identities; and determining, based on the mapping, that the identifier for the second device corresponds to the second user.

In some implementations, the method includes: in response to receiving the context data from the mobile device, sending a request to the second device; and receiving, in response to the request, response data indicating a particular document associated with the second user, where the response data indicates that the particular document has a status of being (i) currently displayed by the second device, (ii) stored locally at the second device, or (iii) included in a document collection of the second user. Identifying the document that is predicted to be relevant to the first user includes identifying the particular document as the document predicted to be relevant to the first user based on the status of the particular document indicated by the response data.

In some implementations, the method includes determining that a particular document is open on multiple devices that are in proximity to the first device. Identifying the document that is predicted to be relevant to the first user includes identifying the particular document as the document predicted to be relevant to the first user based on determining that a particular document is open on multiple devices that are in proximity to the first device. Providing the data indicating the document that is predicted to be relevant to the first user includes providing data indicating that the particular document is predicted to be relevant to the user while the first device is in proximity to the multiple devices and while the particular document is open on the multiple devices.

In some implementations, the method includes: determining a current location of the mobile device; accessing document access data indicating document accesses of the first user and locations where the document accesses occurred; identifying one or more documents previously accessed by the first user at the current location of the mobile device; and providing, to the mobile device, data indicating the one or more documents previously accessed by the first user at the current location of the mobile device.

In some implementations, determining the current location of the mobile device includes determining that the mobile device received a wireless message from a location beacon. Accessing document access data includes accessing document access data that indicates document accesses and user identifiers and device identifiers corresponding to the document accesses. Identifying the one or more documents previously accessed by the first user at the current location of the mobile device includes determining that the document access data associates an access to a particular document with a user identifier for first user and a device identifier for the location beacon.

In some implementations, the method includes: determining a current location of the mobile device; accessing document access data indicating document accesses of a plurality of users; identifying one or more documents based on a measure of document accesses by the plurality of users while at the current location; and providing, to the mobile device, data indicating the one or more documents identified based on the measure of document accesses by the plurality of users while at the current location.

In some implementations, identifying one or more documents based on a measure of document accesses by the plurality of users while at the current location includes: assigning scores to the documents previously accessed by the plurality of users, the scores being assigned based on one or more relationships of the first user with the users in the plurality of users; and selecting a subset of the documents previously accessed by the plurality of users based on the scores.

In some implementations, identifying the document that is predicted to be relevant to the first user includes: determining that the document is included in a personal document collection of the first user and that the document is included in a personal document collection of the second user; and selecting the document from among multiple documents in the personal document collection of the first user based on determining that the document is included in the personal document collection of the first user and that the document is included in the personal document collection of the second user.

In some implementations, the method includes: determining multiple sets of documents that are predicted to be relevant to the first user at the current time and at the current location of the mobile device, the multiple sets of documents each being selected according to different selection criteria; and providing data indicating each of the multiple sets of documents to the mobile device while the second device is in proximity to the mobile device.

In some implementations, the method includes: determining groups of users according to the document access patterns of the users, each group comprising multiple users, where the first user is included in a first group that includes multiple other users; comparing personal document collections of users in the first group that includes the first user; identifying, based on the comparison, documents that are included in the personal document collections of no more than a maximum number of the users in the first group; and providing, to the mobile device, data indicating the identified documents that are included in the personal document collections of no more than a maximum number of the users in the first group.

In some implementations, determining groups of users includes clustering users using a machine learning model.

Other embodiments of these aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue having instructions that, when executed by data processing apparatus, cause the apparatus to perform the actions.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram that illustrates an example of a system for providing contextually relevant document recommendations.

FIG. 2 is a diagram that illustrates an example of data used to determine contextually relevant document recommendations.

FIG. 3 is a diagram that illustrates an example of operations to determine contextually relevant document recommendations.

FIG. 4 is a diagram that illustrates an example of operations to determine contextually relevant document recommendations.

FIG. 5 shows an example of a computing device and a mobile computing device.

Like reference numbers and designations in the various drawings indicate like elements.

### DETAILED DESCRIPTION

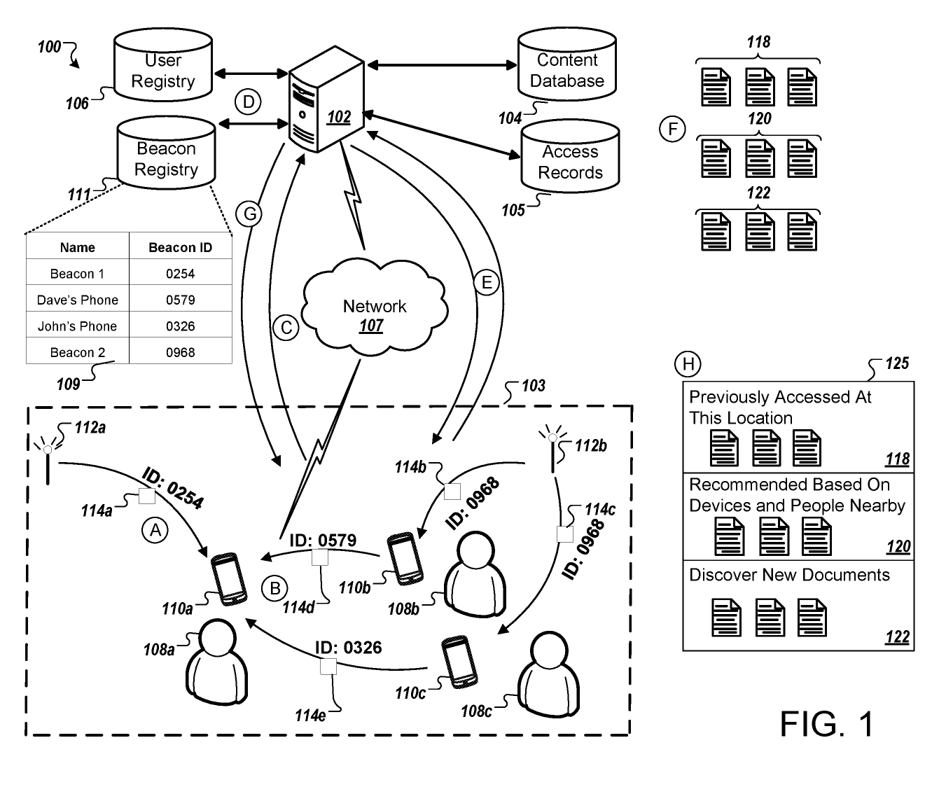

FIG. 1 is a block diagram that illustrates an example of a system 100 for providing contextually relevant document recommendations. The system 100 includes a server 102, client devices 110a-110c, wireless beacons 112a-112b, and a network 107. The server 102 communicates with various data repositories, which can be stored on one or more data storage devices. These data repositories include a content database 104, document access records 105, a user registry 106, and a beacon registry 111. FIG. 1 illustrates various operations in stages (A) to (H) which can be performed in the sequence indicated or in another sequence.

In some implementations, the system 100 provides recommended content, e.g., documents or data identifying documents, to a user based on various different contextual factors. The recommendations can be made using a framework that integrates proximity data, e.g., data indicating devices and users physically nearby, and identity data, e.g., data indicating the user identities and associated information of the users. The system 100 can determine a dynamically customized set of recommendations for a user based on the current context of the user. Document recommendations can be tailored for a user's current situation, allowing the user to quickly access relevant documents without submitting a search query or spending time to explore a file repository.

In many instances, locating appropriate documents among large document sets can be challenging. Manually exploring a file system can be tedious for users. Searching for documents may require a user to be able to formulate an effective search query, and a user may not know enough about the desired document to do so. The difficulty of finding appropriate documents is compounded when many different variations of a document exist or when documents are distributed across multiple locations.

To reduce the amount of time required to access documents, the system 100 can predictively recommend documents that are determined to be relevant to a user's current situation. The system 110 identifies these recommended documents based on various contextual factors. The contextual factors can represent physical characteristics, such as a location of a user, the current time, equipment near the user, and people near the user. In addition, the state or status of devices near the user may be used in determining the recommendations. As a result, data indicating the activities or status of devices near a user can be used to select documents to recommend to the user. As an example, if computer or projector system near the user is currently displaying a document, that document can be identified and indicated as a recommended document. Similarly, the system can determine when multiple computers or other devices near a user are simultaneously displaying a document, and then recommend the document.

Information about physical context can be combined with information about user identities and document access histories to better predict which documents are relevant to a user in a particular context. For example, the personal document collection of a user or a document access history for the user can be assessed to determine which documents the user has viewed most frequently at the user's current location. Similarly, the identities of other users nearby can be determined, and the document collections or document access histories of those users can be analyzed. For example, documents that are in the library of a user and also in the libraries of one or more users currently nearby can be selected as recommended documents.

Other identity data can be used to determine recommendations. For example, when determining recommendations for a first user, information about documents currently or previously viewed by other users can be weighted according to the relationship of the other users to the first user. The system can use relationship data, such as data indicating credentials held by users or roles or relationships in an organization, to automatically weight contextual factors and document usage history data. As a result, for recommendations to a particular user, the documents accessed by a member of the same department can be assigned a higher relevance than documents accessed by members of a different department. Similarly, documents accessed by a user's superior in an organization may be assigned a higher relevance than documents accessed by others in the same department that do not have a direct relationship with the user.

As discussed further below, the identity of a user is used to customize recommendations. Because recommendations can be generated based on identity data, different personalized document recommendations can be provided for different users, even when external contextual factors are the same. Factors such as differences between two users' document access histories, relationships to other users, and contents of personal document collections can result in different recommendations being shown to two different people who are in the same place at the same time.

Referring still to FIG. 1, in the system 100, each of the client devices 110a-110c can be, for example, a desktop computer, a laptop computer, a tablet computer, a wearable computer, a cellular phone, a smart phone, a music player, an e-book reader, a navigation system, or any other appropriate computing device. The server 102 can represent a single computer or multiple computers, which may be distributed across multiple geographic areas. The network 107 can be wired or wireless or a combination of both, and can include the Internet.

FIG. 1 shows an example in which a set of recommended documents are generated for a user 108a of the client device 110a. The client device 110a detects the presence of nearby devices through wireless communications, e.g., over Bluetooth or another short-range wireless communication link. The client device 110a provides this information to the server 102, which uses the information to collect further information about the context of the client device 110a. The server 102 identifies a set of documents identified as relevant to the user 108a, given the current context of the client device 110a. The process of acquiring context information and determining recommended documents can occur in the background, automatically and without distraction to the user. The server 102 provides data indicating the recommended documents to the client device 110a, which indicates the recommended documents on a user interface 125.

During stage (A), client device 110a receives wireless messages from one or more devices. For example, the client device 110a may receive wireless messages over a direct, short-range radio-frequency communication channel. The wireless messages may be transmitted using Bluetooth, Bluetooth Low Energy (BLE), a protocol according to IEEE 802.15, or using another wireless protocol.

The wireless messages may be beacon messages sent by beacon devices. The beacon devices can periodically send a short message that includes an identifier for the beacon. This message, which is often sent repeatedly at short intervals, can announce or advertise the presence of the beacon device. Examples of beacon devices include location beacons that are located in fixed locations and provide periodic messages to facilitate micro-location, e.g., determination of a position in a building. Reception of a wireless message from a location beacon with at least a minimum level of signal strength can indicate that the client device 110a is within a known distance from the location beacon. Location beacons may be placed in different rooms, or different portions of a room, or in another space, to indicate the location of a particular area corresponding to the beacon. Other types of devices can provide beacon messages. In an office setting, computers, projectors, printers, and other devices may include beacons that send wireless messages. Similarly, in a manufacturing setting, pieces of equipment may each have beacons that send beacon messages. A beacon may be attached to any appropriate item, whether the item is movable or in a fixed location, and reception of the beacon message can indicate proximity to the item.

In the example of FIG. 1, the client device 110a receives a wireless message 114a from location beacon device 112a. The messages of each beacon device can include an identifier for the device that sent the beacon message. The wireless message 114a may be a beacon identifier of the beacon device 112a, such as ID: 0254, as shown in FIG. 1.

During stage (B), the client device 110a receives a wireless message from other devices. For example, the client device 110a receives wireless messages 114d, 114e from the client devices 110b, 110c, which are located in the same room 103 as the client device 110a.

The client devices 110a-110c can be cell phones, laptop computers, desktop computers, or other devices as noted above. Each client device 110a-110c can be associated with a respective user 108a-108c. In the example, each of the client devices 110a-110c is a phone, and has been previously registered with the server 102, so that the beacon registry 111 stores data indicating which user 108a-108c (e.g., which user identity) corresponds to each client device 110a-110c.

Each client devices 110a-110c can periodically send wireless messages to advertise its presence and indicate its identity, in the same manner as the beacon devices discussed above. The client device 110b sends wireless message 114d including a beacon identifier “0579” associated with client device 110b. The client device 110c sends a wireless message 114e that includes a beacon identifier “0326” associated with client device 110c. The client device 110a receives these messages 114d, 114e and extracts the beacon identifiers.

During stage (C), the client device 110a sends data indicating its current context to the server 102 over the network 107. For example, the client device 110a sends context data including a list of the beacon identifiers extracted from wireless messages 114a, 114d, 114e that the client device 110 recently received. The extracted beacon identifiers, e.g., “0254,” “0579,” and “0326” provide a snapshot of the devices currently in physical proximity to the client device 110a, and thus indicate the current context of the client device 110a.

The client device 110a may receive wireless messages, extract beacon identifiers, and send the extracted beacon identifiers on an ongoing basis, so the server 102 receives an up-to-date indication of the set of devices near the client device 110a. For example, the client device 110a may send updated context data at a regular interval, e.g., every 5 seconds, every 20 seconds, every minute, etc., or may send updated context information in response to changes in the detected context.

In some implementations, the set of beacon identifiers represents a set extracted from messages received within a predetermined time period, such as the last 30 seconds, or the last 10 seconds. The time period can be set according to the typical transmission frequency of the beacon messages in the system 100, optionally with an additional time buffer. For example, if devices are configured to send beacon messages every 10 seconds, beacon messages that are received more than 20 seconds ago may be considered to not represent the current context of the client device 110a, and so would not be provided to the server 102 to represent the current context.

In some implementations, the client device 110a may filter certain received messages according to the signal strength with which they were received. For example, beacon messages that are received with less than a threshold level of signal strength may be determined to not represent a sufficient level of proximity to the client device 110a, and so the corresponding beacon identifiers are not provided to the server 102.

In some instances, the client device 110a may send additional context data, such as a current location determined using GPS or another location service, movement data indicating movement of the client device 110a, data indicating current applications or documents that are active on the client device 110a, and so on.

During stage (D), the server 102 interprets the beacon identifiers indicated by the context data from the client device 110a. For example, server 102 may access the beacon registry 111 to determine which specific devices are associated with the respective beacon identifiers. The server can use the beacon identifiers to determine the identity of each device detected nearby, as well as the identity of any users associated with the devices. The beacon registry 111 can include data that maps beacon identifiers to information about the devices corresponding to the beacon identifiers. The data mapped to the beacon identifiers can include, for example, a user identifier or other data indicating an owner or registered user of the device, the type of device, capabilities of the device, whether the device is mobile or remains at a fixed location, the current location of the device if known, and so on. This information allows the server 102 to retrieve information about the specific devices that are near the client device 110a, such as the user identities that are registered or otherwise associated with those devices.

The example of FIG. 1 shows a simple table 109 representing data in a beacon registry 111. From this information, the server 102 determines that beacon identifier “0579” corresponds to a phone of user 108c, “Dave,” and that beacon identifier “0579” corresponds to a phone of a user 108b, “John.” The user identities associated with the devices in proximity to the client device 110 are important contextual signals about what information may be currently relevant to the user 108a. Using the information in the registry 111, the server 102 also determines which device is represented by beacon identifier “0254,” and determines that this represents a location beacon, “Beacon 1,” for a fixed location, the room 103. Determining that this location beacon has been detected allows the server 102 to determine that the client device 102 is currently in the location corresponding to this location beacon.

During stage (E), the server 102 communicates with the client devices 110b, 110c that were determined to be in proximity to the client device 110a. The server 102 requests additional information about the current state of these devices 110b, 110c, in response to determining that the devices 110b, 110c are currently in proximity to the client device 110a.

The beacon registry 111 or the user registry 106 can indicate an electronic address that can be used to request information from each device detected near the client device 110a. For example, the beacon registry 111 or the user registry 106 may include identifiers other data that allow devices registered with the server 102 to be contacted. For example, each client device 110a-110c may have an application installed that established communication with the server 102 over the network 107. Through this application's connection with the server 102, or using an IP address or other electronic address, the server 102 can send requests for information about the current state of the devices 110b, 110c. The server 102 may select which devices to request information from based on the device types indicated in the beacon registry 111, since some devices, such as phones, computers, etc., may have the capability to provide state information, while others, such as location beacons, may not.

The server 102 may request information about the state of the devices 110b, 110c, and the devices 110b, 110c can provide various types of information in response. For example, the devices 110b, 110c can provide data indicating documents currently active (e.g., open or being used), or documents currently being viewed (e.g., currently displayed by a device). Thus, the server 102 may obtain content data indicating which document(s) or portions of documents the client devices 110b-110c currently display. As another example, the devices 110b, 110c can provide information indicating documents currently selected or present in an active folder of a file system. As another example, the devices 110a, 110b can each provide a list of documents that are stored locally, or a list of documents in a user's library or document collection. In some implementations, the contents of a user library may be synchronized with the server 102 or another server, so the contents of a user's library may already be available to the server 102.

The state data from the devices 110b, 110c can indicate specific documents with a document identifier, e.g., a unique identification number, a document name, a URL, or other identifying information. Documents may be managed and served to clients by the server 102 or another server system. For example, the content database 104 may represent a central, managed repository of documents that are accessed by various different devices throughout an enterprise network. As another example, the content database 104 may include an index or database of information about various documents and their content and characteristics, whether or not the documents themselves are stored in the content database 104.

The state data provided by the client devices 110b, 110c to the server 102 may include a list of beacon identifiers detected by the client devices 110b, 110c. For example, the client device 110b may send a list of beacon identifiers corresponding to the client devices 110a, 110c, the location beacon 112a, and an additional beacon device 112b. The identifiers for these beacons can be used to verify the context of the client device 110a, e.g., to verify that the client device 110b also receives a message from client device 110a, which confirms the proximity of the two devices. The beacon identifiers from the client device 110b can also provide additional information regarding the context of the client device 110b, since the client device 110b may detect beacons that the client device 110a does not. For example, the client device 110b, 110c may be near a piece of machinery represented by beacon device 110b, while the client device 110a is sufficiently far from the beacon device 112b that the client device 110a does not receive a message from this beacon device 112b. The identifier “0968” from the beacon device 112b can provide information about what is relevant to the client devices 110b, 110c and their users, which in turn can indicate what may be relevant to the user 108a who is nearby.

During stage (F), the server 102 selects documents that are predicted to be relevant to the user 108a in the current context of the user 108a. The documents that are most relevant are selected as recommended documents for the user 108a, to be indicated while the client device 110a the current context. The server 108a uses the context data received from the client device 108a, the context data obtained from nearby devices 110b, 110c, and document access records 105 to determine which documents are likely to be most relevant. The server 102 can also use other information, such as data indicating relationships among users, which may be indicated by the user registry 106.

The server 102 can determine a set of recommended documents for each of multiple categories. The recommended documents for each category are selected using different selection techniques. For example, the recommended documents for different categories may be selected using different combinations of context information (e.g., location, time, devices nearby, people nearby, etc.), using different selection criteria, using different relevance scoring techniques, or using different types of document access records. The documents selected for each category may each be assigned relevance scores and ranked relative to the other documents selected for the same category.

For a first category, the server 102 can determine a first set of recommended documents 118 based on a user's current location and the history of document accesses for that location. The recommended documents can be weighted to prioritize documents that the user has previously accessed (e.g., viewed, opened, saved, etc.) at the current location. As a result, as a user moves from location to location, this set of documents can change to show documents most frequently accessed or most recently accessed in the current location. To select these documents, the server 102 may use document access records 105 to determine which documents a user has accessed in the current location of the client device 110a. Each access can be given a weight based on how recently the access occurred, and how closely the context for the prior access matches the current context. For example, an access on the previous day may be weighted to have higher relevance than an access a week ago. Similarly, accesses can be weighted according to how close the time of day or day of the week of the previous access was to the current time of day or day of the week. The weighted values for the prior accesses to a document by the user can be aggregated, e.g., summed, to determine an overall relevance score for the document.

The server can weight previous document accesses according to whether devices or users currently in proximity of the client device 110 were also in proximity during a previous access to a document. The document access records 104 may indicate that a particular document was accessed by the user 108a in the room 103 while the client device 110b was also present. Since the client device 110b is present in the current context of the client device 110a, the particular document can be weighted to indicate a high relevance based on the prior access in a similar context. The server 102 can boost the relevance score for the particular document as a result.

In some implementations, the documents that may be included in the first set of documents 118 is not limited to documents that the user 108a has previously accessed. The server 102 may take into account accesses by many users to determine which documents are accessed most frequently at a particular location or when a particular beacon device is detected. The access records 105 can be analyzed to determine, based on access patterns, which documents are appropriate for particular context elements. For example, a piece of machinery may have an attached beacon device 112b that advertises its presence. The access records 105 may indicate that users frequently look up a specific user manual when they are within proximity to the beacon device 112b. From these records, the server 102 can identify the user manual as being frequently accessed when users are near the beacon device 112b, and thus the server 102 can indicate the user manual as a recommended document when a user is near the beacon device 112b. In this manner, the server 102 can determine the relevance of the user manual document to the contextual factor of proximity to the beacon device 112b, which allows the server to indicate the user manual for the machinery without evaluating the content of the user manual or knowing the characteristics of the machinery. In some implementations, the server 102 may have access to stored information about the machinery represented by the beacon device 112b, and the server 102 may use relevance of document content to the stored information, but this often will not be necessary since document access patterns can effectively indicate which documents are most likely to be used.

For a second category, the server 102 can determine a second set of recommended documents 120 can be determined based on the identities of users currently located near the user 108a. As discussed above, the presence of a user may be inferred by the detection of a wireless message from a device associated with a user. If a device indicates in its context data that a message from a particular phone, tablet computer, or other mobile device is received, then the server 102 can consider the user who is registered with or logged in to the nearby device to be present. To select the second set of recommended documents, the server 102 can evaluate the contents of personal document collections of users who are near each other. For example, the server 102, after determining that users 108b, 108c are nearby, may compare the list of documents in the document collection of the user 108a with the contents of the document collections of the users 108b, 108c. Items that match (e.g., are included in the document collection of the user 108a and the document collection of at least one of the users 108b, 108c) can be identified as potential documents to recommend. The more people at a location whose document collections include a document, the higher the relevance that is assigned to the document by the server 102.

The comparison of documents in common among the document collections of nearby users can effectively indicate which document is relevant in the current context. For example, the user 108a may have many documents in a document library, respectively relating to different projects. If a co-worker enters the user's office, then the co-worker's document collection may include documents relating to a particular project that the user and the co-worker are working on together. Since documents for the particular project are included in the document library of both the user and the co-worker, the server 102 can identify the commonality and to recommend those documents that are relevant to both users present.

The state of the devices of nearby users is also used to determine the second set of documents 120. For example, documents currently active on nearby devices can be identified as highly relevant at the current time and place. If one of the client devices 110b, 110c is currently displaying a document, or has a document open, while the client device 110a is nearby, that document can be identified as relevant in the current context. A relevance score for the document can be increased if multiple devices have the same document active at the same time. If multiple people are discussing the same document in a meeting and they each view the document on their devices, for example, the server can determine that the document is being viewed and select the document as a recommended document for others in the meeting who may not be viewing the document. In general, the server 102 can determine whether a threshold number of devices (e.g., 1 device, 2 devices, 5 devices, etc.) near the client device 110a have a document active. If at least the threshold number do have the document active, the document can be included in the second set of documents 120.

When multiple matching items are found based on users nearby, the server 102 may assess the relevance according additional factors, such as the frequency of access or how recent the users present access a document, and whether a document was accessed by one or both users while the users are in proximity to each other. For example, each instance of access to a document by the user 108a or the users 108b, 108c can be assigned a weight based on how recently the access occurred, and how similar the current context is to the prior context when access occurred. If a document was accessed when the user 108a was present, the relevance score for the document can be increased. If user 108a and one of the users 108b, 108c concurrently accessed the document, the relevance of the document can be increased further.

For a third category, the server 102 may determine a third set of documents 122 based on commonalities among user document access patterns. For example, the server 102 may cluster users into groups according to the documents that they access. For example, the server 102 may use a machine learning model to classify users according to the document accesses by the users and the content of the documents accessed. In this manner, the server 102 determines groups of users that tend to access the same documents or documents of similar topics.

Once a group of similar users is determined, the server 102 may compare the personal document libraries of the users in the group. Differences in the libraries can indicate documents that may be of interest to other members of the group, but are not widely known. For example, the server 102 can identify documents that are in the document libraries of one of the members of a group, and not in document libraries of any of the other members of the group. Similarly, the server 102 can identify documents that are included in fewer than a threshold number of document libraries of members of the group. These documents that are relatively uncommon among the document collections of the users in a group can be included in the third set of documents 122 as recommended documents, allowing other members of the group to discover documents of which they may not be aware.

During stage (G), the server 102 sends data indicating recommended documents to the client device 110a over the network 107. These recommended documents represent documents that are predicted or estimated to be relevant based on the current context of the client device 110a. The recommended documents can be one or more documents in the sets 118, 120, 122 discussed above. In some implementations, up to a predetermined maximum number of documents from each of the different sets of documents 118, 120, 122 are provided. For example, for each of the three categories, up to five documents with the highest relevance scores are indicated to the client device 110a as recommended documents. To indicate the recommended documents, the server 102 can provide a list of document identifiers, e.g., document identification numbers, URLs, file names, or other references, that enable the client device 110a to access the recommended documents, e.g., from a server, from local storage of the client device 110a, or from another document repository.

The server 102 may apply a filter or threshold to limit the set of recommended documents to only documents determined to have sufficient relevance for the current context of the client device 110a. For example, the relevance scores of documents in the documents in the sets 118, 120, 122 can be compared to a minimum relevance threshold value. Documents that do not have at least the minimum relevance score can be excluded. This may result in indicating few or no recommended documents at certain times or for certain categories.

During stage (H), in response to the data received from the server 102, the client device 110a displays an indication of the recommended documents to the user 108a. The illustrated example shows an example of a user interface 125 in which indications of each of the different sets of documents 118, 120, 122 are shown. As a result, the client device 110a displays indications, e.g., names, icons, hyperlinks, etc., of multiple sets of recommended documents. The indications on the user interface 125 can be interactive, so that user input to select the indication for a document causes the client device 110a to display the document.

In some implementations, the client device 110a receives data about recommended documents from the server 102 in the background, and the user interface 125 is not shown until a user requests to view recommended documents. From a user interface of an application, for example, from a view of a user's document library, the user may provide an input or command to cause the user interface 125 to be displayed. For example, the user 108 may perform a swipe motion in a particular direction on a touchscreen display of the client device 110a to indicate that recommendations should be shown. In response to the interaction, the client device 110a transitions to a view of the user interface 125. The user 108a may access any of the recommended documents indicated by selecting one of the icons or other document indications.

In some implementations, the client device 110a may provide a notification, such as a message or an audible notification, to alert the user 108 that new recommendations have been received. This notification may be provided when the client device 110a receives the data from the server 102 indicating the recommended documents.

In some implementations, the client device 110a may delay providing a notification of recommended documents until the client device 110a retrieves one or more of the recommended documents over a network. By downloading recommended documents in advance of notifying the user, the client device 110a can hide the network transfer delay from the user to improve responsiveness. After some or all of the recommended documents are stored at the client device 110a, the notification is provided, and the user can provide input to cause the user interface 125 to be displayed. Then, when the user selects a document, the client device 110a can display the selected document without delay, because the content of the selected document has already been transferred to the client device 110a.

The operations of stages (A) to (H) illustrate a single example of providing recommended documents to the client device 110a based on a current context. The server 102 can repeat the operations of stages (A) to (H) as the context of the client device 110a changes to provide new recommendations appropriate for the changed context. Similarly, the server can perform the operations of stages (A) to (H) to determine recommendations for other users. As a result, the server 102 can concurrently determine and provide recommendations to devices of various different users.

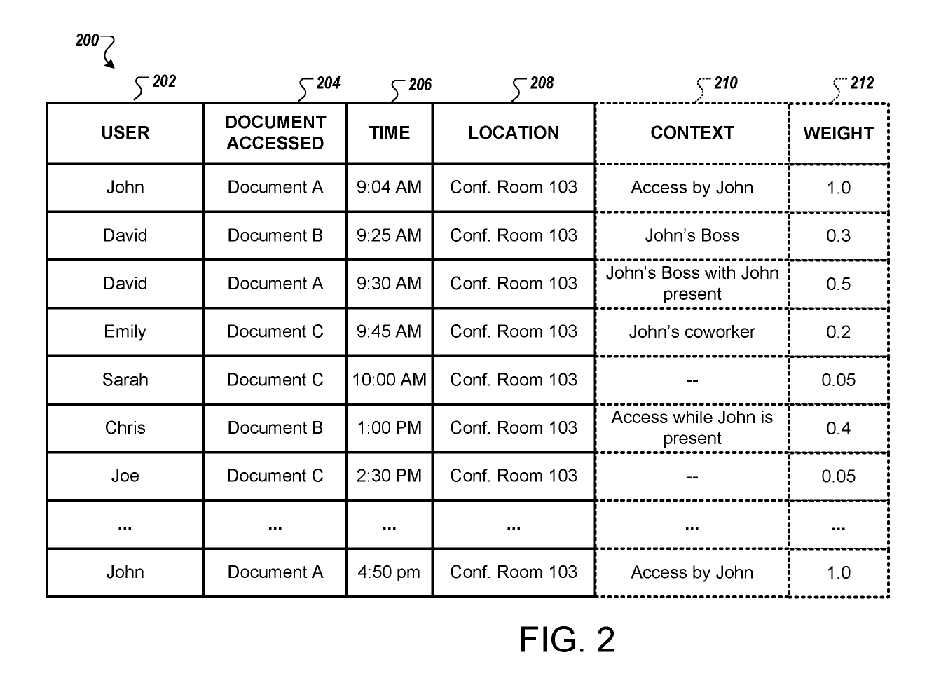

FIG. 2 is a diagram that illustrates an example of a table 200 of data used to determine contextually relevant document recommendations. In particular, FIG. 2 shows an example representing determining the first set of documents 118, for the first category discussed in FIG. 1.

The table 200 shows examples of access history data for a specific location over a particular period of time. From among a data set of many accesses from multiple locations, the data set may be filtered to a set that is most relevant to a user. For example, from context data indicating that a user named “John” is currently in conference room 103, the server 102 may identify records that represent recent document accesses in conference 103. For example, table 200 illustrates a log of document accesses by devices located at conference room 103. This data may represent accesses during the current day, or the current week, or during another time period.

The table 200 includes rows that each correspond to different document access events that were logged. Each document access record, e.g., each row of table 200, can indicate a user identifier 202 that indicate which user accessed the document, a document identifier 204 indicating which document was accessed, a time 206 or time range that the access occurred, and a location 208 where the access occurred. Other information may also be stored in document access records, such as a type of access (e.g., view, save, edit, share, download, upload, etc.), a duration of access, a device identifier for the device that performed the access, state information for the device that performed the access (e.g., which applications or other documents were open or used concurrently with the document access), and/or context information of the device that performed the access (e.g., indicating other devices or users in the same location when access occurred). Each of these types of information may be used to assess the potential relevance to a user that is currently in the conference room 103.

Using the document access records in the table 200, the server 102 can determine how different document accesses relate to the particular user for whom recommendations are being generated, e.g., “John” in the example. The server 102 can also evaluate the context in which each access occurred, e.g., which devices or people were present, and how closely the context matches the current context of John's device. For example, the server 102 can determine context information 210 that represents the identity of the person who performed the document access, as well as the person's relationship to John. From this context information 210, as well as other factors, the server 102 can assign a weight to each document access. A prior access to a document by John can be weighted highly, while a prior access to a document by others is given less weight. Among accesses by others, accesses can be weighted according to whether John was present when the access occurred and whether the user has a particular relationship to John. For example, an access to a document by John's boss may have more weight than an access by a peer in John's department. Accesses by people who do not have a relationship to John can be given some weight, but typically much less than accesses by users that have a relationship with John.

For each document that was accessed in the location, a relevance score for the document can be determined by aggregating the weights for accesses to the document. For example, Document A was accessed twice by John while at the location and once by John's boss while John was present. The sum of the weights for these accesses is 2.5, representing a relatively high level of relevance. Document B was accessed by others twice, but the combined weights for these accesses is 0.7, indicating a much lower relevance. Document C was accessed three times, but because the users that made the accesses did not have close relationships with John or have John present, those accesses only have a total score of 0.3.

The server 102 can generate the relevance scores and rank the documents indicated by the table 204 according to the relevance scores. Up to a predetermined number of the documents, e.g., a top-ranked subset, can be determined as the set of documents 118. The server 102 may also optionally limit the set of documents recommended to only those that have at least a minimum relevance. For example, a minimum relevance threshold score of 1.0 may be set, in which case the server would only indicate Document A as a recommended document. Document B and Document C, which were assigned relevance scores that do not satisfy the threshold, would not be indicated as recommended in the current context of the client device 110a.

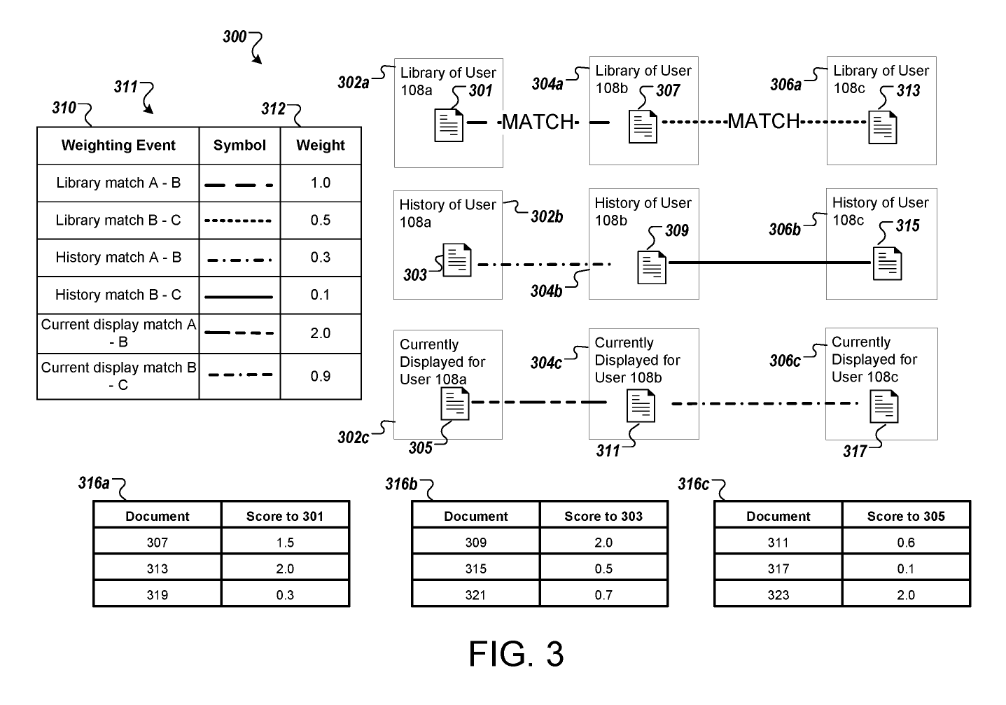

FIG. 3 is a diagram that illustrates an example of operations to determine contextually relevant document recommendations. The figure shows various examples of data and operations that may be used to determine recommended documents based on identified users nearby. This process can involve identifying matching documents associated with other users, such as users 108b and 108c, and documents associated with user 108a who is nearby.

In some implementations, the server 102 can determine recommended documents 122 for the other users' history by matching documents between libraries of users in proximity to one another. For example, the server 102 may receive a beacon ID from client device 110a, determine an address of the client device 110a, and obtain content data from the client device 110a. Similarly, the server 102 may perform the same steps and obtain content data from the client devices 110b and 110c. In response, the server 102 may determine recommendation documents 122 by comparing the obtained content data from each of the client devices 110.

In some implementations, each client device 110 may include a library for content, a history viewed list, and content for what the client device 110 currently displays. Specifically, the client device 110a can include a library 302a that may include documents 301; a history list 302b that may include documents 303; and, a currently displayed 302c that may include documents 305. Similarly, the client device 110b can include a library 304a that may include documents 307; a history list 304b that may include documents 309; and, a currently displayed 304c that may include documents 305. Similarly, the client device 110c can include a library 306a that may include documents 313; a history list 306b that may include documents 315; and, a currently displayed 306c that may include documents 317. For example, each of the documents may relate to a subject relevant to a particular user, such as engineering, product development, resumes, and program management, to name a few examples.

In some implementations, the server 102 may compare contents associated with each library, history list, and what is currently displayed between multiple client devices. The server 102 may make the following exemplary comparisons: contents of library 302a of user 108a to contents of library 304a of user 108b; contents of library 304a of user 108b to contents of library 306a of user 108c; contents of library 302a of user 108a to contents of library 306a of user 108c; contents of a history list 302b of user 108a to contents of a history list 304b of user 108b; the contents of the history list 304b of user 108b to contents of a history list 306b of user 108c; the contents of the history list 302b of user 108a to contents of a history list 306b of user 108c; contents of currently displayed 302c of user 108a to contents of currently displayed 304c of user 108b; contents of the currently displayed 304c of user 108b to contents of the currently displayed 306c of user 108c; and, contents of the currently displayed 302a of user 108a to contents of the currently displayed 306c of user 108c.

In some implementations, the server 102 may assign a weight value in the weight column 312 in the weight table 311 in response to determining content matching between the client devices 110. The server 102 may assign the weight values proportional to how similar documents are between client devices. Specifically, the higher the document similarity between the client devices, the higher the assigned weight value. For example, the server 102 may assign a weight of 1.0 to a portion of a library match between user 108a and user 108b. The server 102 may assign a weight of 0.5 between a portion of a library match between user 108b and user 108c. The recommendation server may assign a weight of 0.3 between a portion of a history list match between user 108a and user 108b. The recommendation server may assign a weight of 0.1 between a portion of a history list match between user 108b and user 108c. The recommendation server may assign a weight of 2.0 between a portion of what client devices 110a and 110b currently display between user 108a and user 108b. The recommendation server may assign a weight of 0.9 between a portion of what client devices 110b and 110c currently display between user 108b and user 108c.

In some implementations, the server 102 may score the content comparisons between the client devices 110. In the illustrated example, score table 316 illustrates content similarity scores associated with a particular document. For example, the score table 316a may illustrate the content similarity scores associated with the documents 301 in library 302a. The score table 316a illustrates a score of 1.5 associated with the documents 307 in library 304a an, a score of 2.0 associated with the documents 313 in library 306a, and a score of 0.3 associated with the documents 319 in an another library. In some implementations, the server 102 may determine a predetermined amount of top recommended documents from each score table 316 to provide to user 108′s client device 110. For example, the server 102 may select the top two documents from each score table 316a, score table 316b, and score table 316c to provide to client device 110. In other implementations, the server 102 may select a predetermined amount of top recommended documents based on satisfying a predetermined threshold from each score table 316 to provide as recommended documents 122.

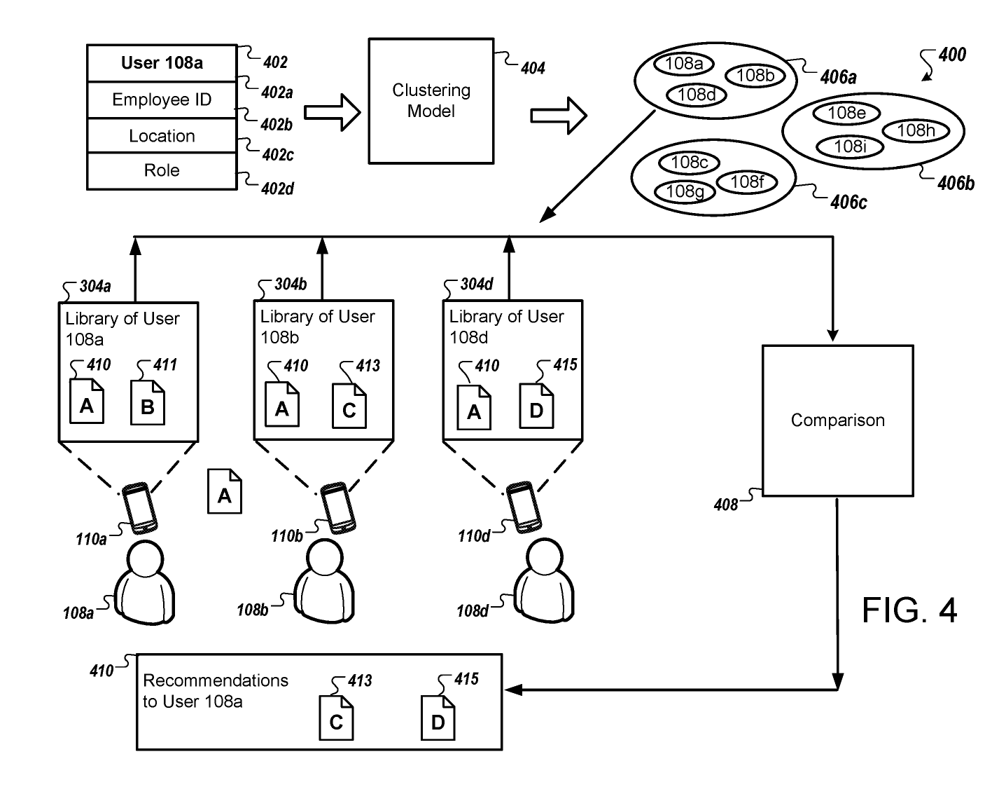

FIG. 4 is a diagram that illustrates an example of operations to determine contextually relevant document recommendations. The figure shows operations that may be used to select the recommended documents 122 shown in FIG. 1, using results of a clustering model 404. The clustering model 404 may be a machine learning model used to cluster users into groups according to the document access patterns of the users. As a result, the information about the users in a group can be used to determine recommended documents. For example, the server 102 can help a particular user discover new documents that may be of interest by identifying documents that have been accessed by, or are included in the personal document collections of, users in the same group or cluster as the particular user.

The server 102 can determine recommended documents 122 for users by grouping user according to certain user characteristics or user behavior patterns. In some implementations, the clustering model 404 may include one or more neural network layers trained to perform clustering. For example, a neural network may be trained to classify set of objects in such a way that the objects in the same group (e.g., a cluster) are more similar to each other to those in other clusters. To classify a set of objects, the clustering model 404 can evaluate context, e.g., employee data. In some implementations, the clustering model 404 may include a neural network.

Various clustering algorithms may be used. For example, the clustering model 404 may use a hierarchical clustering algorithm where objects may be more closely related than to objects farther away. In another example, the clustering model 404 may use distribution-based clustering where objects with the same distribution define clusters. Additionally, the clustering model 404 may use hard clustering and/or soft clustering. Hard clustering refers to a determination that each object belongs to a cluster based on one or more parameters, such as having the same employee title. Soft clustering, or fuzzy clustering, refers to a determination that each object belongs to a cluster to a certain degree, e.g., a determination of an object's likelihood of belonging to a cluster. In the fuzzy clustering, an object may belong to one or more clusters based on the likelihood of belonging to each of the one or more clusters.

In some implementations, the recommendations server 102 may retrieve information associated with each user 108 from the beacon registry 111. The beacon registry 111 may store information associated with each user 108 along with the beacon information. For example, the information associated with each user 108 may include a name 402a of user 108a, an employee ID 402b of user 108a, a location 402c of user 108a, and a role 402d of user 108a. The name, employee ID, location, and role of user 108a may be grouped together in an object. The server 102 may provide the object as input to the neural networks of the clustering model 404, as shown in FIG. 4. The server 102 may provide an object for each user 108 in the beacon registry 111 to the neural networks of the clustering model 404 to properly characterize each cluster. In response, the clustering model 404 may output a cluster ID. The cluster ID determines which group an input object belongs. Specifically, the clustering model 404 may output a cluster ID 406a associated with management, a cluster ID 406b associated with engineering, and a cluster ID 406c associated with IT technical support. Alternatively, the clustering model 404 may output a cluster ID 406a associated with a user being on level 1 of a building, a cluster ID 406b associated with a user being on level 2 of a building, and a cluster ID 406c associated with a user being on level 3 of a building.

In some implementations, the server 102 may retrieve a library, a history list, or a currently displayed document on an associated client device 110 associated with each object in a cluster from content database 104. For example, the server 102 retrieves libraries for each user 108a, user 108b, and user 108d from cluster 406a associated with management. The server 102 may retrieve library 304a for user 108a, library 304b for user 108b, and library 304d for user 108d from content database 104. Each library contains content including one or more documents relevant to a particular user. For example, library 304a may include document 410 and document 411, library 304b may include document 410 and 413, and library 304d may include document 410 and 415. The server 102 continues this process for each cluster.

In some implementations, the server 102 may determine from each library document recommendations 122 to provide to each client device 110. The server 102 provides a client device 110 associated with a user 108 recommended documents 122 from libraries of other users in the same cluster not in the library of the client device 110. For example, the recommended server 102 provides client device 110a associated with user 108a recommended documents 122 from libraries of client devices 110b and 110d associated with user 108b and user 108c in the same cluster, such as cluster 406a, not in the library of client device 110a. The server 102 determines which recommended documents 122 to provide to client device 110a by passing the documents from each library 304 through a comparison module 408. Specifically, the comparison module 408 determines in a first comparison, similar documents found in library 304a of user 108a to documents found in library 304b of user 104b and library 304d of user 104d. In response, the comparison module 408 then provides each of the remaining documents in libraries 304b and 304d as recommendations 410 to client device 110a of user 108a. For example, the server 102 determines libraries 304a, libraries 304b, and libraries 304d each have document 410 in common. Therefore, the recommendation module 102 determines to provide document 413 in library 304b and document 415 in library 304d to client device 110a as recommended documents 410.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

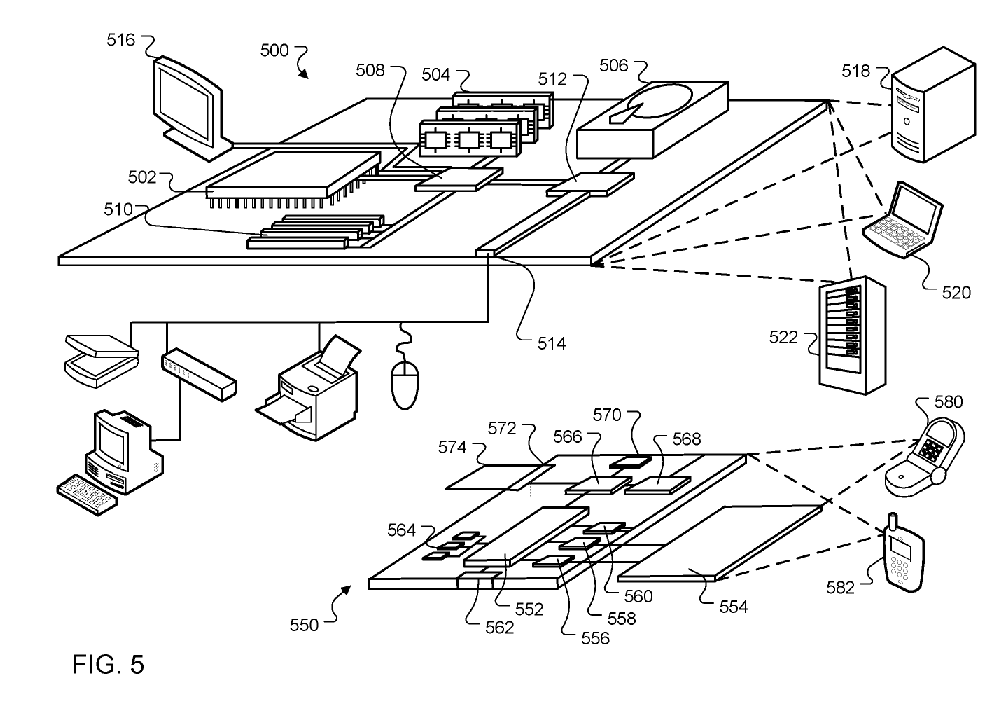

FIG. 5 shows an example of a computing device 500 and a mobile computing device 550 that can be used to implement the techniques described here. The computing device 500 is intended to represent various forms of digital computers, such as laptops, desktops, workstations, personal digital assistants, servers, blade servers, mainframes, and other appropriate computers. The mobile computing device 550 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 500 includes a processor 502, a memory 504, a storage device 506, a high-speed interface 508 connecting to the memory 504 and multiple high-speed expansion ports 510, and a low-speed interface 512 connecting to a low-speed expansion port 514 and the storage device 506. Each of the processor 502, the memory 504, the storage device 506, the high-speed interface 508, the high-speed expansion ports 510, and the low-speed interface 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as a display 516 coupled to the high-speed interface 508. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 504 stores information within the computing device 500. In some implementations, the memory 504 is a volatile memory unit or units. In some implementations, the memory 504 is a non-volatile memory unit or units. The memory 504 may also be another form of computer-readable medium, such as a magnetic or optical disk.

The storage device 506 is capable of providing mass storage for the computing device 500. In some implementations, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 502), perform one or more methods, such as those described above. The instructions can also be stored by one or more storage devices such as computer- or machine-readable mediums (for example, the memory 504, the storage device 506, or memory on the processor 502).

The high-speed interface 508 manages bandwidth-intensive operations for the computing device 500, while the low-speed interface 512 manages lower bandwidth-intensive operations. Such allocation of functions is an example only. In some implementations, the high-speed interface 508 is coupled to the memory 504, the display 516 (e.g., through a graphics processor or accelerator), and to the high-speed expansion ports 510, which may accept various expansion cards (not shown). In the implementation, the low-speed interface 512 is coupled to the storage device 506 and the low-speed expansion port 514. The low-speed expansion port 514, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 518, or multiple times in a group of such servers. In addition, it may be implemented in a personal computer such as a laptop computer 520. It may also be implemented as part of a rack server system 522. Alternatively, components from the computing device 500 may be combined with other components in a mobile device (not shown), such as a mobile computing device 550. Each of such devices may contain one or more of the computing device 500 and the mobile computing device 550, and an entire system may be made up of multiple computing devices communicating with each other.

The mobile computing device 550 includes a processor 552, a memory 564, an input/output device such as a display 554, a communication interface 566, and a transceiver 568, among other components. The mobile computing device 550 may also be provided with a storage device, such as a micro-drive or other device, to provide additional storage. Each of the processor 552, the memory 564, the display 554, the communication interface 566, and the transceiver 568, are interconnected using various buses, and several of the components may be mounted on a common motherboard or in other manners as appropriate.

The processor 552 can execute instructions within the mobile computing device 550, including instructions stored in the memory 564. The processor 552 may be implemented as a chipset of chips that include separate and multiple analog and digital processors. The processor 552 may provide, for example, for coordination of the other components of the mobile computing device 550, such as control of user interfaces, applications run by the mobile computing device 550, and wireless communication by the mobile computing device 550.

The processor 552 may communicate with a user through a control interface 558 and a display interface 556 coupled to the display 554. The display 554 may be, for example, a TFT (Thin-Film-Transistor Liquid Crystal Display) display or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may provide communication with the processor 552, so as to enable near area communication of the mobile computing device 550 with other devices. The external interface 562 may provide, for example, for wired communication in some implementations, or for wireless communication in other implementations, and multiple interfaces may also be used.

The memory 564 stores information within the mobile computing device 550. The memory 564 can be implemented as one or more of a computer-readable medium or media, a volatile memory unit or units, or a non-volatile memory unit or units. An expansion memory 574 may also be provided and connected to the mobile computing device 550 through an expansion interface 572, which may include, for example, a SIMM (Single In Line Memory Module) card interface. The expansion memory 574 may provide extra storage space for the mobile computing device 550, or may also store applications or other information for the mobile computing device 550. Specifically, the expansion memory 574 may include instructions to carry out or supplement the processes described above, and may include secure information also. Thus, for example, the expansion memory 574 may be provided as a security module for the mobile computing device 550, and may be programmed with instructions that permit secure use of the mobile computing device 550. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier, such that the instructions, when executed by one or more processing devices (for example, processor 552), perform one or more methods, such as those described above. The instructions can also be stored by one or more storage devices, such as one or more computer- or machine-readable mediums (for example, the memory 564, the expansion memory 574, or memory on the processor 552). In some implementations, the instructions can be received in a propagated signal, for example, over the transceiver 568 or the external interface 562.

The mobile computing device 550 may communicate wirelessly through the communication interface 566, which may include digital signal processing circuitry where necessary. The communication interface 566 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 568 using a radio-frequency. In addition, short-range communication may occur, such as using a Bluetooth, WiFi, or other such transceiver (not shown). In addition, a GPS (Global Positioning System) receiver module 570 may provide additional navigation- and location-related wireless data to the mobile computing device 550, which may be used as appropriate by applications running on the mobile computing device 550.

The mobile computing device 550 may also communicate audibly using an audio codec 560, which may receive spoken information from a user and convert it to usable digital information. The audio codec 560 may likewise generate audible sound for a user, such as through a speaker, e.g., in a handset of the mobile computing device 550. Such sound may include sound from voice telephone calls, may include recorded sound (e.g., voice messages, music files, etc.) and may also include sound generated by applications operating on the mobile computing device 550.

The mobile computing device 550 may be implemented in a number of different forms, as shown in the figure. For example, it may be implemented as a cellular telephone 580. It may also be implemented as part of a smart-phone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, while a client application is described as accessing the delegate(s), in other implementations the delegate(s) may be employed by other applications implemented by one or more processors, such as an application executing on one or more servers. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method performed by one or more computers, the method comprising:
receiving, by the one or more computers, context data indicating physical context of a mobile device, the context data indicating a second device in proximity to the mobile device;
identifying, by the one or more computers, a first user associated with the mobile device;
identifying, by the one or more computers, a second user associated with the second device;
identifying, by the one or more computers, a document that is predicted to be relevant to the first user, the document being identified from among multiple documents in a document collection based at least in part on records indicating document accesses associated with the second user; and
providing, by the one or more computers, data indicating the document that is predicted to be relevant to the first user while the second device is in proximity to the mobile device.

2. The method of claim 1, wherein receiving the context data comprises receiving, from the mobile device over a network, data indicating a set of identifiers extracted from wireless messages received by the mobile device from one or more devices in proximity to the mobile device, the set of identifiers including at least an identifier for the second device.

3. The method of claim 2, wherein identifying the second user associated with the second device comprises:
accessing data indicating a mapping of identifiers to user identities; and
determining, based on the mapping, that the identifier for the second device corresponds to the second user.

4. The method of claim 1, further comprising:
in response to receiving the context data from the mobile device, sending a request to the second device;
receiving, in response to the request, response data indicating a particular document associated with the second user, wherein the response data indicates that the particular document has a status of being (i) currently displayed by the second device, (ii) stored locally at the second device, or (iii) included in a document collection of the second user;
wherein identifying the document that is predicted to be relevant to the first user comprises identifying the particular document as the document predicted to be relevant to the first user based on the status of the particular document indicated by the response data.

5. The method of claim 1, further comprising determining that a particular document is open on multiple devices that are in proximity to the first device;
wherein identifying the document that is predicted to be relevant to the first user comprises identifying the particular document as the document predicted to be relevant to the first user based on determining that a particular document is open on multiple devices that are in proximity to the first device; and
wherein providing the data indicating the document that is predicted to be relevant to the first user comprises providing data indicating that the particular document is predicted to be relevant to the user while the first device is in proximity to the multiple devices and while the particular document is open on the multiple devices.

6. The method of claim 1, further comprising:
determining a current location of the mobile device;
accessing document access data indicating document accesses of the first user and locations where the document accesses occurred;
identifying one or more documents previously accessed by the first user at the current location of the mobile device; and
providing, to the mobile device, data indicating the one or more documents previously accessed by the first user at the current location of the mobile device.

7. The method of claim 6, wherein determining the current location of the mobile device comprises determining that the mobile device received a wireless message from a location beacon;
wherein accessing document access data comprises accessing document access data that indicates document accesses and user identifiers and device identifiers corresponding to the document accesses;
wherein identifying the one or more documents previously accessed by the first user at the current location of the mobile device comprises determining that the document access data associates an access to a particular document with a user identifier for first user and a device identifier for the location beacon.

8. The method of claim 1, further comprising:
determining a current location of the mobile device;
accessing document access data indicating document accesses of a plurality of users;
identifying one or more documents based on a measure of document accesses by the plurality of users while at the current location; and
providing, to the mobile device, data indicating the one or more documents identified based on the measure of document accesses by the plurality of users while at the current location.

9. The method of claim 8, wherein identifying one or more documents based on a measure of document accesses by the plurality of users while at the current location comprises:
assigning scores to the documents previously accessed by the plurality of users, the scores being assigned based on one or more relationships of the first user with the users in the plurality of users; and
selecting a subset of the documents previously accessed by the plurality of users based on the scores.

10. The method of claim 1, wherein identifying the document that is predicted to be relevant to the first user comprises:
determining that the document is included in a personal document collection of the first user and that the document is included in a personal document collection of the second user; and
selecting the document from among multiple documents in the personal document collection of the first user based on determining that the document is included in the personal document collection of the first user and that the document is included in the personal document collection of the second user.

11. The method of claim 1, comprising:
determining multiple sets of documents that are predicted to be relevant to the first user at the current time and at the current location of the mobile device, the multiple sets of documents each being selected according to different selection criteria; and
providing data indicating each of the multiple sets of documents to the mobile device while the second device is in proximity to the mobile device.

12. The method of claim 1, further comprising:
determining groups of users according to the document access patterns of the users, each group comprising multiple users, wherein the first user is included in a first group that includes multiple other users;
comparing personal document collections of users in the first group that includes the first user;
identifying, based on the comparison, documents that are included in the personal document collections of no more than a maximum number of the users in the first group; and
providing, to the mobile device, data indicating the identified documents that are included in the personal document collections of no more than a maximum number of the users in the first group.

13. The method of claim 12, wherein determining groups of users comprises clustering users using a machine learning model.

14. A system comprising:
one or more computers; and
one or more computer-readable media storing instructions that, when executed by the one or more computers, cause the one or more computers to perform operations comprising:
receiving, by the one or more computers, context data indicating physical context of a mobile device, the context data indicating a second device in proximity to the mobile device;
identifying, by the one or more computers, a first user associated with the mobile device;
identifying, by the one or more computers, a second user associated with the second device;
identifying, by the one or more computers, a document that is predicted to be relevant to the first user, the document being identified from among multiple documents in a document collection based at least in part on records indicating document accesses associated with the second user; and
providing, by the one or more computers, data indicating the document that is predicted to be relevant to the first user while the second device is in proximity to the mobile device.

15. The system of claim 14, wherein receiving the context data comprises receiving, from the mobile device over a network, data indicating a set of identifiers extracted from wireless messages received by the mobile device from one or more devices in proximity to the mobile device, the set of identifiers including at least an identifier for the second device.

16. The system of claim 15, wherein identifying the second user associated with the second device comprises:
accessing data indicating a mapping of identifiers to user identities; and
determining, based on the mapping, that the identifier for the second device corresponds to the second user.

17. The system of claim 14, wherein the operations further comprise:
in response to receiving the context data from the mobile device, sending a request to the second device;
receiving, in response to the request, response data indicating a particular document associated with the second user, wherein the response data indicates that the particular document has a status of being (i) currently displayed by the second device, (ii) stored locally at the second device, or (iii) included in a document collection of the second user;
wherein identifying the document that is predicted to be relevant to the first user comprises identifying the particular document as the document predicted to be relevant to the first user based on the status of the particular document indicated by the response data.

18. One or more non-transitory computer-readable media storing instructions that, when executed by the one or more computers, cause the one or more computers to perform operations comprising:
receiving, by the one or more computers, context data indicating physical context of a mobile device, the context data indicating a second device in proximity to the mobile device;
identifying, by the one or more computers, a first user associated with the mobile device;
identifying, by the one or more computers, a second user associated with the second device;
identifying, by the one or more computers, a document that is predicted to be relevant to the first user, the document being identified from among multiple documents in a document collection based at least in part on records indicating document accesses associated with the second user; and
providing, by the one or more computers, data indicating the document that is predicted to be relevant to the first user while the second device is in proximity to the mobile device.

19. The one or more non-transitory computer-readable media of claim 18, wherein receiving the context data comprises receiving, from the mobile device over a network, data indicating a set of identifiers extracted from wireless messages received by the mobile device from one or more devices in proximity to the mobile device, the set of identifiers including at least an identifier for the second device.

20. The one or more non-transitory computer-readable media of claim 19, wherein identifying the second user associated with the second device comprises:
accessing data indicating a mapping of identifiers to user identities; and
determining, based on the mapping, that the identifier for the second device corresponds to the second user.
